(19) United States
(12) Patent Application Publication
(10) Pub. No.: US 2022/0338004 A1
(43) Pub. Date: Oct. 20, 2022

(54) COMMUNICATION DEVICE AND NON-TRANSITORY COMPUTER-READABLE MEDIUM STORING COMPUTER-READABLE INSTRUCTIONS FOR COMMUNICATION DEVICE

(71) Applicant: BROTHER KOGYO KABUSHIKI KAISHA, Nagoya (JP)

(72) Inventor: Hiroshi SHIBATA, Yatomi (JP)

(21) Appl. No.: 17/721,619

(22) Filed: Apr. 15, 2022

(30) Foreign Application Priority Data
Apr. 16, 2021 (JP) 2021-069958

(51) Int. Cl. H04W 12/0431; H04W 12/069; H04W 12/06

(52) U.S. Cl. CPC H04W 12/0431; H04W 12/069; H04W 12/068; H04W 84/12

(57) ABSTRACT

A communication device may include: a communication interface; an operation unit; and a controller configured to: change a state of the communication device from a first state to a second state different from the first state when the operation unit receives instruction for establishing first connection with a first external device via the interface while the communication device's state is the first state, in which the first state is a state in which both use of the first connection and use of a second connection with a second external device via the interface are permitted, the second state is a state in which the use of the first connection is permitted and the use of the second connection is not permitted, the first connection is connection conforming to a first communication standard, and the second connection is connection conforming to a second communication standard different from the first communication standard.

### CROSS-REFERENCE TO RELATED APPLICATION

This application claims priority to Japanese Patent Application No. 2021-069958 filed on Apr. 16, 2021, the contents of which are hereby incorporated by reference into the present application.

### BACKGROUND

The Wi-Fi Alliance (“Wi-Fi Alliance” is a registered trademark of Wi-Fi Alliance) developed WPA3, which is a new communication standard in the Wi-Fi scheme. In WPA3, a new-generation security protocol is provided. In communication standards other than WPA3, other security protocols may be provided.

### SUMMARY

Due to the development of the new communication standard, a situation in which various communication standards are simultaneously available may be assumed. The present teachings disclose an art for appropriately receiving a service provided by a specific communication standard in the above-mentioned situation.

A communication device disclosed herein may comprise:

a communication interface; an operation unit; and

a controller, wherein

the controller is configured to:

change a state of the communication device from a first state to a second state being different from the first state in a case where the operation unit receives an instruction for establishing a first connection with a first external device via the communication interface while the state of the communication device is the first state,

wherein the first state is a state in which both use of the first connection and use of a second connection with a second external device via the communication interface are permitted,

the second state is a state in which the use of the first connection is permitted and the use of the second connection is not permitted,

the first connection is a connection conforming to a first communication standard, and

the second connection is a connection conforming to a second communication standard being different from the first communication standard.

The operation unit receiving an instruction for establishing the first connection conforming to the first communication standard is assumed to mean that the user wishes to receive a service provided by the first communication standard. According to the above feature, in a case where the user of the communication device is assumed to be wishing to receive the service provided by the first communication standard, the state of the communication device is changed from the first state to the second state. In the second state, although the use of the first connection conforming to the first communication standard is permitted, the use of the second connection conforming to the second communication standard is not permitted. In a situation in which the first communication standard and the second communication standard are simultaneously available, the service provided by the first communication standard can be appropriately received.

The other communication device disclosed herein may comprise:

a communication interface;

an operation unit;

and a controller, wherein

the controller is configured to;

cause the communication device to operate in a third state in a case where the operation unit receives an instruction for establishing a first connection with a first external device via the communication interface; and

cause the communication device to operate in a fourth state in a case where the operation unit receives an instruction for establishing a second connection with a second external device via the communication interface,

wherein the third state is a state in which use of the first connection is permitted and use of the second connection is not permitted,

the fourth state is a state in which both the use of the first connection and the use of the second connection are permitted,

the first connection is a connection conforming to a first communication standard, and

the second connection is a connection conforming to a second communication standard being different form the first communication standard.

The operation unit receiving an instruction for establishing the first connection conforming to the first communication standard is assumed to mean that the user wishes to receive a service provided by the first communication standard. According to the above feature, in a case where the user of the communication device is assumed to be wishing to receive the service provided by the first communication standard, the controller causes the communication device to operate in the third state. In the third state, although the use of the first connection conforming to the first communication standard is permitted, the use of the second connection conforming to the second communication standard is not permitted. In a situation in which the first communication standard and the second communication standard are simultaneously available, the service provided by the first communication standard can be appropriately received.

Further, the operation unit receiving an instruction for establishing a second connection conforming to the second communication standard is assumed to mean that the user wishes to receive a service provided by the second communication standard. According to the above feature, in a case where the user of the communication device is assumed to be wishing to receive the service provided by the second communication standard, the controller causes the communication device to operate in the fourth state. In the fourth state, not only the use of the first connection conforming to the first communication standard but the use of the second connection conforming to the second communication standard is also permitted. In the situation in which the first communication standard and the second communication standard are simultaneously available, the service provided by the second communication standard can be appropriately received.

A control method, computer program for the communication device and a non-transitory computer-readable medium storing computer-readable instructions for implementing the communication device above are also novel and useful.

### BRIEF DESCRIPTION OF DRAWINGS

FIG. 1 illustrates a configuration of a communication system.

FIG. 2 illustrates a sequence diagram of Case C1 in which no WPA3-incompatible AP exists.

FIG. 3 illustrates a sequence diagram of Case C2 in which a WPA3-incompatible AP exists.

FIG. 4 illustrates a sequence diagram of Case C3, which is continuation of Case C1.

FIG. 5 illustrates a problematic example.

FIG. 6 illustrates a sequence diagram of Case C4 which addresses the problematic example of FIG. 5.

FIG. 7 illustrates a table representing a relationship between an AP and an MFP.

FIG. 8 illustrates a sequence diagram of a specific case.

FIG. 9 illustrates a table representing a relationship between an AP and an MFP.

FIG. 10 illustrates a configuration of a communication system.

FIG. 11 illustrates a sequence diagram of a specific case.

FIG. 12 illustrates a configuration of a communication system.

FIG. 13 illustrates a sequence diagram of a specific case.

FIG. 14 illustrates a table representing a relationship between an AP and a server.

### DETAILED DESCRIPTION

### First Embodiment

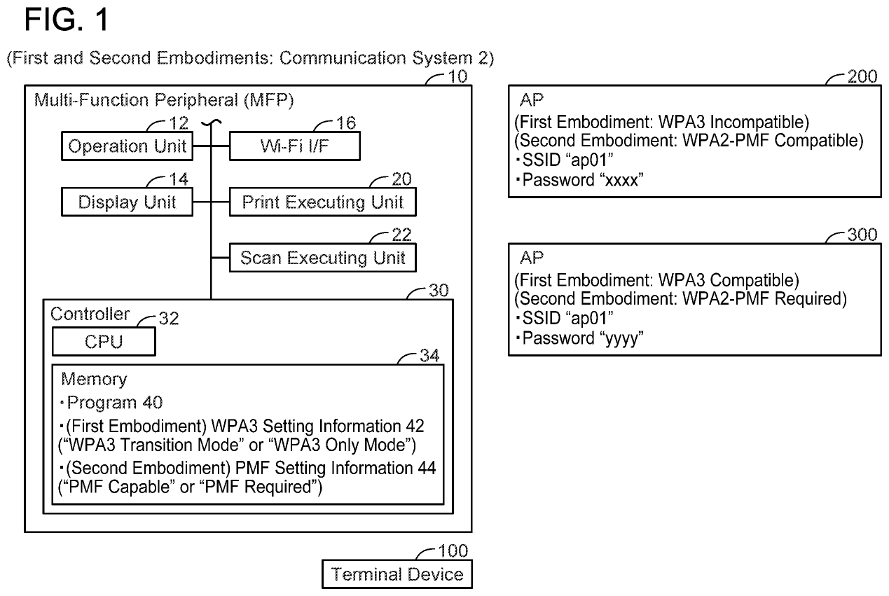

(Configuration of Communication System 2; FIG. 1)

As shown in FIG. 1, a communication system 2 comprises a multifunction peripheral (MFP) 10, a terminal device 100, and access points (AP) 200, 300. Each of the APs 200, 300 is configured to form a wireless local area network (LAN). The MFP 10 is configured to be connected to a wireless LAN formed by an AP (e.g. 200) and to perform communication with another device (e.g. the terminal device 100) connected to this wireless LAN. The terminal device 100 comprises a mobile terminal, a desktop PC, and/or laptop PC, for example.

(Configuration of MFP 10; FIG. 1)

The MFP 10 is a peripheral device (e.g. peripheral device of the terminal device 100) configured to perform a print function, a scan function, for example. The MFP 10 comprises an operation unit 12, a display unit 14, a Wi-Fi interface 16, a print executing unit 20, a scan executing unit 22, and a controller 30. Each unit 12 to 30 is connected to a busline (sign omitted). Hereafter, an interface will be referred to as simply “I/F”.

The operation unit 12 comprises a plurality of keys. The user is able to input various instructions into the MFP 10 by operating the operation unit 12. The display unit 14 is a display configured to display various kinds of information. The display unit 14 may also function as a touch screen (i.e., the operation unit 12).

The Wi-Fi I/F 16 is a wireless I/F configured to perform wireless communication conforming to Wi-Fi (“Wi-Fi” is a registered trademark of Wi-Fi Alliance) standard. The Wi-Fi standard is a standard configured to perform wireless communication according to for example, 802.11 standard of the Institute of Electrical and Electronics Engineers, Inc. (IEEE), and also its subordinate standards (e.g., 802.11a, 11b, 11g, 11n).

Further, the Wi-Fi I/F 16 supports WPA3-Personal and WPA3-Enterprise. Personal is a scheme which authenticates a station in a small-sized wireless LAN such as for personal uses (in homes). Enterprise is a scheme which authenticates a station in a large-sized wireless LAN such as in companies. In Enterprise, an authentication server (see a third embodiment), which is configured to perform authentication conforming to 802.1X of the IEEE, authenticates a station in a Wi-Fi standard. On the other hand, in Personal, no authentication server is used, and a station is authenticated by, for example, an AP using Pre-Shared Key (PSK).

WPA3 is a communication standard which was formulated subsequently after WPA2 by Wi-Fi Alliance (“Wi-Fi Alliance” is a registered trademark of Wi-Fi Alliance). A next-generation security protocol is provided in WPA3. For example, in WPA3, Simultaneous Authentication of Equals (SAE) is newly supplied as a scheme for authenticating a station.

Further in WPA3, wireless connection is protected by Protected Management Frames (PMF). On the other hand, in WPA2, wireless connection may be protected by PMF or may not be protected by PMF.

The print executing unit 20 comprises a print mechanism such as an inkjet scheme, and/or a laser scheme. The scan executing unit 22 comprises a scan mechanism such as a Charge Coupled Device (CCD) image sensor and/or Contact Image Sensor (CIS).

The controller 30 comprises a CPU 32 and a memory 34. The CPU 32 is configured to perform various types of processing in accordance with a program 40 stored in the memory 34. The memory 34 is composed of a volatile memory, a non-volatile memory, and/or the like.

The memory 34 further stores WPA3 setting information 42. The WPA3 setting information 42 indicates one of plural items including setting “WPA3 Transition Mode” and setting “WPA3 Only Mode”. The setting “WPA3 Transition Mode” is a setting in which both establishment of wireless connection conforming to WPA3 and establishment of wireless connection conforming to WPA2 are permitted. For example, in the setting “WPA3 Transition Mode”, both authentication of station using PSK and authentication of station using SAE are permitted. Here, PSK is a scheme available in a standard being WPA2 or an earlier version. Further, the setting “WPA3 Only Mode” is a setting in which the establishment of wireless connection conforming to WPA3 is permitted and the establishment of wireless connection conforming to WPA2 is not permitted. For example, in the setting “WPA3 Only Mode”, the authentication of station using PSK is not permitted and the authentication of station using SAE is permitted.

At a shipment stage of the MFP 10, the WPA3 setting information 42 indicates the setting “WPA3 Transition Mode”. The WPA3 setting information 42 after power of the MFP 10 was turned on for the first time indicates the setting “WPA3 Transition Mode” by default. In a variant, the default of the WPA3 setting information 42 may indicate another setting (for example, setting in which WPA2 only is used) different from both the setting “WPA3 Transition Mode” and the setting “WPA3 Only Mode”.

(Configuration of AP 200, 300; FIG. 1)

The AP 200 does not support WPA3. The AP 200 supports WPA2. Hereafter, incapability to support WPA3 may be termed “WPA3-incompatible”. The AP 200 stores a Service Set Identifier (SSID) “ap01” that identifies a wireless network formed by the AP 200 and a password “xxxx” to be used for this wireless network.

The AP 300 supports WPA3. Hereafter, supporting of WPA3 may be termed “WPA3-compatible”. The AP 300 stores an SSID “ap01” same as that of the AP 200 and a password “yyyy” used for a wireless network formed by the AP 300. In a variant, the password of the AP 300 may be the same as the AP 200's password “xxxx”.

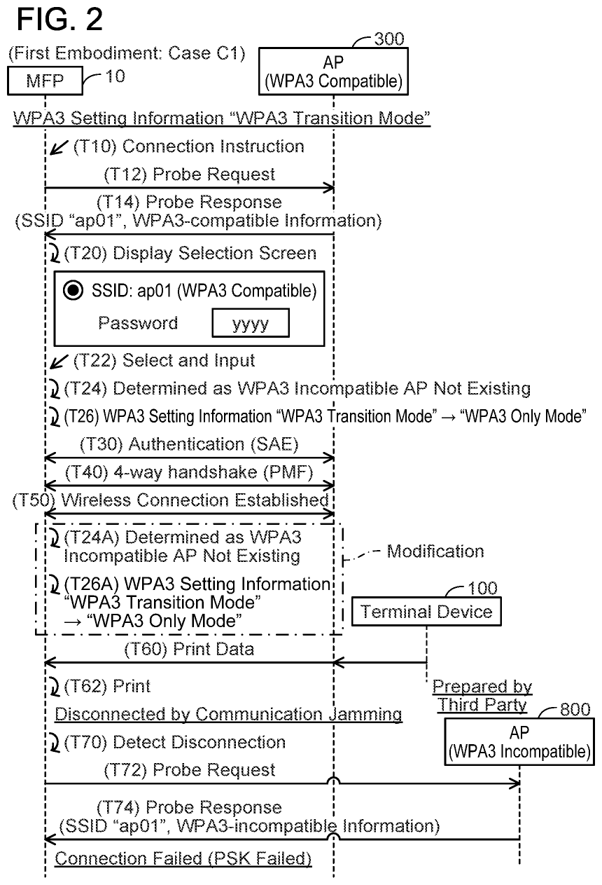

(Case C 1; FIG. 2)

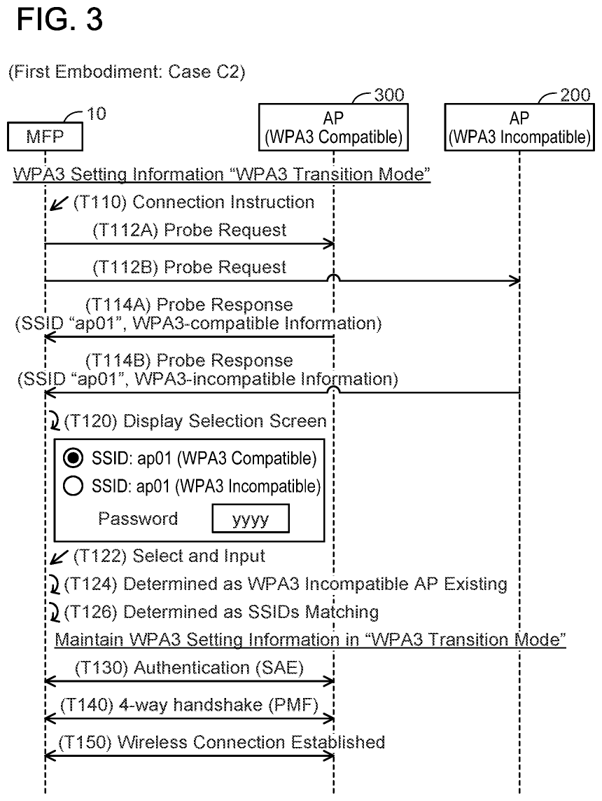

With reference to FIG. 2, a specific case C1 realized by the communication system 2 of the present embodiment will be described. The present case is a case where in a situation in which there is no WPA3-incompatible AP around the MFP 10, wireless connection is established between the MFP 10 and an AP. In the present case and also cases C2 to C4 of FIGS. 3 to 6 to be described later, Personal of WPA3 is used. At an initial stage in the present case, the WPA3 setting information 42 of the MFP 10 indicates the setting “WPA3 Transition Mode” by default. In the first embodiment and the second, third embodiments to be described later, all to-be-described communications performed by the MFP 10 are performed via the Wi-Fi I/F16. Hereinafter, when a process regarding communication is described, a recitation “via the Wi-Fi I/F16” may be omitted. Hereinbelow, for easier understanding, operations which the CPUs (e.g., CPU 32) of the respective devices execute may be described with the respective devices (e.g., MFP 10) as a subject of action instead of describing the CPU as the subject of action.

When the MFP 10 accepts an operation for establishing wireless connection on the operation unit 12 in T10, the MFP 10 sends a Probe request in T12 for searching for AP(s) existing around the MFP 10 to external by broadcast. In the present case, a WPA3-compatible AP 300 exists and no other APs exist around the MFP 10. Accordingly, in T14, the MFP 10 receives a Probe response in response to the Probe request only from the AP 300. This Probe response includes the SSID “ap01” of the AP 300 and WPA3-compatible information indicating that the AP 300 supports

WPA3. The WPA3-compatible information includes, for example, information indicating use of SAE.

In subsequent T20, the MFP 10 displays a selection screen for selecting one AP from among one or more APs existing around the MFP 10 (hereafter, “the one or more surrounding APs”). The selection screen includes, for each of the one or more surrounding APs, the SSID in the Probe response received from the respective AP, a button for selecting this SSID, and a message indicating whether the respective AP supports WPA3 or not. In the present case, the selection screen includes the SSID “ap01” of the AP 300 only. Further, the selection screen includes an input column for an AP password in addition to a list of SSID(s).

In T22, the user operates the operation unit 12 of the MFP 10, and selects the SSID “ap01” in the selection screen and inputs the password “yyyy”.

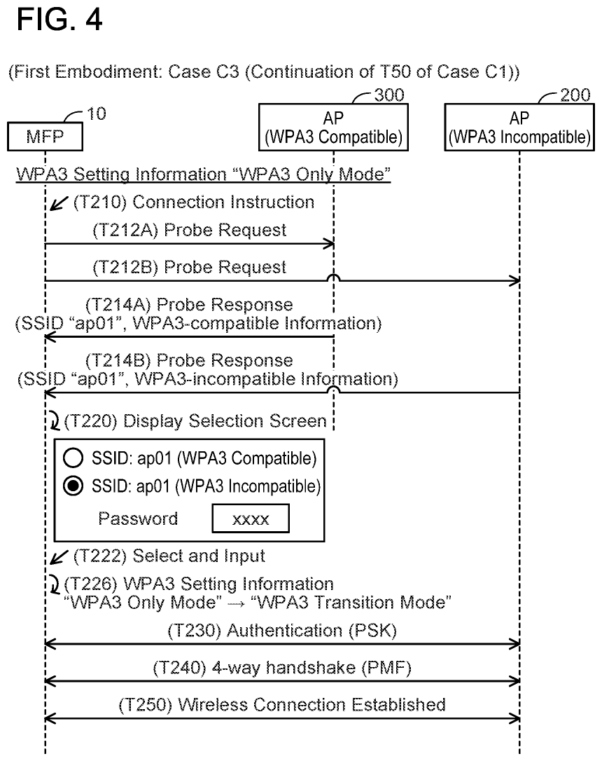

When the MFP 10 receives the selection of the SSID “ap01” of the WPA3-compatible AP 300 and the input of the password “yyyy” in T22, in T24, the MFP 10 determines whether a WPA3-incompatible AP exists, in addition to the WPA3-compatible AP, among the one or more surrounding APs. Specifically, the MFP 10 determines whether a Probe response not including WPA3-compatible information (hereafter, “incompatible Probe response”) exists in addition to the Probe response including the WPA3-compatible information among the one or more Probe responses received from the one or more surrounding APs. Then, when the incompatible Probe response exists among the one or more Probe responses, the MFP 10 determines that the WPA3-incompatible AP exists among the one or more surrounding APs. On the other hand, when no incompatible Probe response exists among the one or more surrounding APs, the MFP 10 determines that no WPA3-incompatible AP exists among the one or more surrounding APs. If the WPA3-incomatible AP is selected, the processes of T24 and T26 are not performed, and a process for establishing wireless connection with the WPA3-incompatible AP is performed (see T230 to T250 of FIG. 4). The processes of T24 and T26 are not performed also if only the WPA3-incompatible AP(s) exist as the one or more surrounding APs.

In the present case, one WPA3-compatible AP 300 exists and no WPA3-incompatible AP exists around the MFP 10. In the present case, in T24 the MFP 10 determines that no WPA3-incompatible AP exists among the one or more surrounding APs, and proceeds to the process of T26. A case where there is WPA3-incompatible AP(s) exist in addition to the WPA3-compatible

AP among the one or more surrounding APs will be described later in FIG. 3.

In T26, the MFP 10 changes the WPA3 setting information 42 from the setting “WPA3 Transition Mode” to the setting “WPA3 Only Mode”.

In T30, communication of Authentication for the AP 300 to authenticate the MFP 10 is performed between the MFP 10 and the AP 300 selected in T22. In Authentication, authentication conforming to SAE is performed, and when the authentication succeeds, an encryption key generated using the password “yyyy” inputted in T22 is provided to both the AP 300 and the MFP 10. Here, after the communication of Authentication succeeds, communication of Association is performed (not shown).

In T40, the MFP 10 performs communication of 4-way handshake with the AP 300 using the encryption key provided in T30. Due to this, in T50, wireless connection for performing wireless communication conforming to the Wi-Fi standard is established between the MFP 10 and the AP 300. In the present case, the WPA3 setting information 42 of the MFP 10 indicates the setting “WPA3 Only Mode”, and the AP 300 supports WPA3. Accordingly, in the 4-way handshake of the present case, communication for receiving management by PMF is performed. Then, the wireless connection of T50 is managed by PMF.

For example, in a situation where both the MFP 10 and the terminal device 100 are connected to the wireless LAN formed by the AP 300, the terminal device 100 sends print data indicating an image of print target to the MFP 10 via the AP 300 in T60.

When the MFP 10 receives the print data from the terminal device 100 in T60, the MFP 10 causes the print executing unit 20 to print the image indicated by the received print data in T62.

For example, a situation is assumed in which an ill-intentioned third party attempts to connect the MFP 10 to a wireless network formed by an AP 800, which was prepared by this third party instead of the AP 300. An SSID of the AP 800 is set to “ap01”, being the same as the SSID of the AP 300. The AP 800 is a WPA3-incompatible AP and does not support a security protocol provided by WPA3. Due to this, the AP 800 provides vulnerable security as compared to the AP 300. For example, the third party attempts to intercept communication using the AP 800 with the vulnerable security.

In the above situation, the third party firstly intercepts the communication between the AP 300 and the MFP 10, and cuts off the wireless connection between the AP 300 and the MFP 10. In T70, the MFP 10 detects this cutting of the wireless connection. In order to attempt re-establishment of the wireless connection, the MFP 10 sends a Probe request to external by broadcast in T72. In T74, since the communication with the AP 300 is intercepted, the MFP 10 receives a Probe response from the AP 800 in response to the Probe request. This Probe response includes the SSID “ap01” and WPA3 incompatible information indicating that the AP 800 supports a standard being WPA2 or an earlier version.

In the present case, in the above T26, the WPA3 setting information 42 has been changed to the setting “WPA3 Only Mode”. As mentioned above, in the setting “WPA3 Only Mode”, the authentication of station using PSK is not permitted and the authentication of station using SAE is permitted. In the present case, because the AP 800 is WPA3-incompatible, the AP 800 attempts to authenticate station using PSK. Because the authentication of station using PSK is not permitted by the MFP 10, this attempted authentication fails. As a result of this, the establishment of the wireless connection between the AP 800 and the MFP 10 fails.

For example, a comparison example is assumed in which the above process of T26 is not performed and the WPA3 setting information 42 is maintained in the setting “WPA3 Transition Mode”. As mentioned above, in the setting “WPA3 Transition Mode”, both the authentication of station using PSK and the authentication of station using SAE are permitted. Due to this, in this comparison example, the authentication of station using PSK which the AP 800 attempted succeeds, and wireless connection can be established between the AP 800 and the MFP 10. Contrary to this, according to the present case, the wireless connection between the AP 800 and

MFP 10 is not established, and thus the third party interception of communication using the AP 800 can be suppressed.

Further, the operation unit 12 accepting the instruction for establishment of wireless connection with the AP 300, that is, the user selecting the SSID “ap01” in T22, is presumed to mean that the user wishes to receive a service provided by WPA3 SAE (that is, communication with a relatively high encryption level). In the present case, when the user is presumed as wishing to receive the service provided by SAE (T22), the WPA3 setting information 42 is changed from the setting “WPA3 Transition Mode” to the setting “WPA3 Only Mode” (T26). In a situation where SAE of WPA3 and PSK of WPA2 or an earlier version are simultaneously available, the service provided by SAE of WPA3 can be properly received.

(Case C2; FIG. 3)

With reference to FIG. 3, another specific case C2 will be described. The present case is a case in which wireless connection is established between the MFP 10 and an AP in a situation where a WPA3-incompatible AP and a WPA3-compatible AP exist around the MFP 10. The initial stage of the present case is the same as that of Case C1 of FIG. 2.

T110, T112A, T112B are the same as T10, T12 in FIG. 2. In the present case, around the MFP 10, two APs being 200, 300 exist, where the AP 200 is a WPA3-incompatible AP and the AP 300 is a WPA3-compatible AP. Accordingly, in T114A, T114B, the MFP 10 receives a Probe response from each of the two APs 200, 300. The Probe response of the AP 200 includes the SSID “ap01” and the WPA3-incompatible information.

In T120, the MFP 10 displays a selection screen including two SSIDs “ap01”. T122 is the same as T20 of FIG. 2.

In T124, the MFP 10 performs a determination the same as T24 of FIG. 2. In the present case, around the MFP 10, in addition to the WPA3-compatible AP 300, the WPA3-incompatible AP 200 exists. Due to this, in T124, the MFP 10 determines that a WPA3-incompatible AP exists in addition to the WPA3-compatible AP 300 among the one or more surrounding APs, and proceeds to T126.

In T126, the MFP 10 determines whether the SSID of the WPA3-incompatible AP among the one or more surrounding APs is identical to the SSID of the WPA3-compatible AP which was selected in T122. In the present case, the SSID “ap01” of the AP 300 is identical to the SSID “ap01” of the AP 200. Due to this, the MFP 10 determines that both SSIDs are identical, and skips the process of T26 of FIG. 2. That is, the WPA3 setting information 42 is maintained in the setting “WPA3 Transition Mode”. T130 to T150 are the same as T20 to T50 in FIG. 2. On the other hand, if the SSIDs are determined as not identical, the MFP 10 performs processes the same as T26 to T50 of FIG. 2. In a variant, the determination of T126 may be performed before the determination of T124.

As mentioned above, the same SSID “ap01” is assigned to each the AP 200 and the AP 300. The AP 200 is an AP which was, for example, installed by the user before installation of the AP 300. For example, a comparison example is assumed in which the WPA3 setting information 42 is changed to the setting “WPA3 Only Mode” when the SSID of the WPA3-compatible AP 300 is selected in the situation where not only the WPA3-compatible AP 300 but also the WPA3-incompatible AP 200 exists around the MFP 10. In this comparison example, a situation where the MFP 10 is brought apart from the AP 300 after the wireless connection with the AP 300 has been established, is assumed. In this case, the wireless connection with the AP 300 is cut off, and the MFP 10 attempts to connect to another wireless network identified by the same SSID “ap01” (that is, wireless network formed by the AP 200). However, because the WPA3 setting information 42 has been changed to the setting “WPA3 Only Mode”, despite there is the past AP 200 around the MFP 10, the MFP 10 fails to establish wireless connection with the AP 200. Contrary to this, in the present case, the WPA3 setting information 42 is maintained in the setting “WPA3 Transition Mode”. As mentioned above, in the setting “WPA3 Transition Mode”, the establishment of wireless connection with a WPA3-incompatible AP is permitted. Due to this, for example, failure in establishing wireless connection with the past AP 200 can be suppressed, and thus user convenience can be ensured. In a variant, the above comparison example may be adopted.

(Case C3; FIG. 4) With reference to FIG. 4, Case C3 which is continuation from T50 of Case C1 in FIG. 2 will be described. In the present case, after the wireless connection with the AP 300 has been established in T50, the WPA3-incompatible AP 200 is installed around the MFP 10. At the initial stage in the present case, the WPA3 setting information 42 of the MFP 10 indicates the setting “WPA3 Only Mode”.

T210 to T220 are the same as T110 to T120 of FIG. 3. In T222, the user selects the SSID “ap01” of the WPA3-incompatible AP 200, and inputs the password “xxxx” in the selection screen.

In T226, the MFP 10 changes the WPA3 setting information 42 from the setting “WPA3 Only Mode” to the setting “WPA3 Transition Mode”. T230 is the same as T30 of FIG. 2 except that the authentication conforming to PSK is performed. T240, T250 are the same as T40, T50 of FIG. 2. In a variant, in T240, communication for being managed by PMF may not be performed.

In the present case, the SSID “ap01” of the WPA3-incompatible AP 200 being selected in the selection screen after the wireless connection with the AP 300 has been established is presumed to mean that the user wishes to receive a service provided by PSK of WPA2. According to the present case, when the user is presumed as wishing to receive the service provided by PSK (T222), the WPA3 setting information 42 is changed from the setting “WPA3 Only Mode” to the setting

“WPA3 Transition Mode” (T226). In the situation where SAE of WPA3 and PSK of WPA2 or an earlier version are simultaneously available, the service provided by PSK can be suitably received.

(Problematic Example)

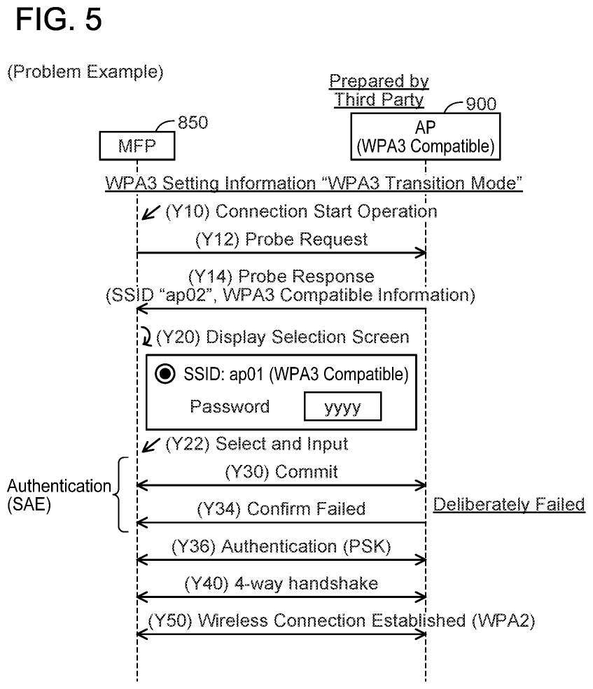

With reference to FIG. 5, a problematic example for explaining further effects of the present embodiment will be described. WPA3 setting information of an MFP 850 in the present problematic example indicates the setting “WPA3 Transition Mode”, and the WPA3 setting information of the MFP 850 is not to be changed. In the present problematic example, a third party prepares an AP 900, and attempts to connect the MFP 850 to a wireless network being formed by the AP 900. The SSID of the AP 900 is set to be “ap01” the same as the SSID of the AP 300. The AP 900 is a WPA3-compatible AP.

Y10 to Y22 are the same as T10 to T22 of FIG. 2 except that the MFP 850 and the AP 900 are used. Y30 to Y34 indicate details of SAE Authentication in the present problematic example. In Y30, the MFP 850 performs communication of Commit with the AP 900. In the Commit communication, a message requesting for execution of SAE is sent from the MFP 850 to the AP 900. If the AP 900 accepts the request by this message, SAE Authentication succeeds. In the problematic example however, the AP 900 has been designed by the third party to disregard the request by this message. Due to this, in Y34, the MFP 850 receives, from the AP 900, a message of Confirm Failed indicating that SAE Authentication failed.

In the present problematic example, the WPA3 setting information of the MFP 850 indicates the setting “WPA3 Transition Mode”. Due to this, in Y36, the MFP 850 performs PSK

Authentication instead of SAE Authentication. Y40, Y50 are the same as T40, T50 of FIG. 2 except that an encryption key generated by PSK is used. Although the AP 900 supports WPA3, the AP 900 operates as a WPA3-incompatible AP. The third party attempts to intercept, for example, communication using the AP 900 with vulnerable security.

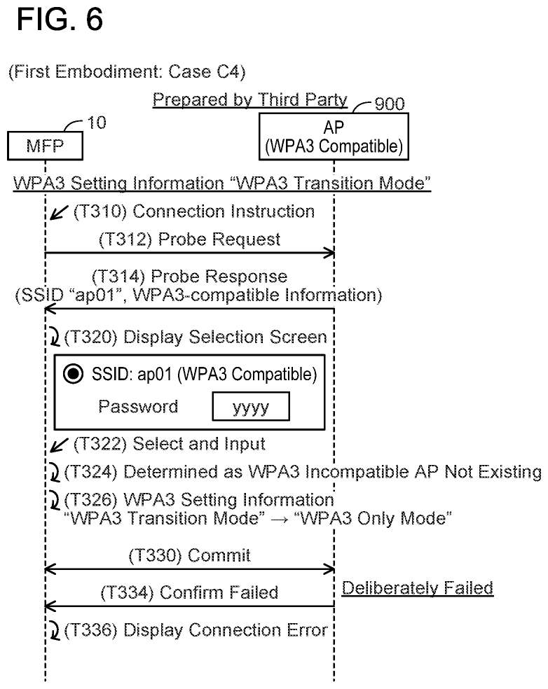

(Case C4; FIG. 6)

With reference to FIG. 6, Case C4 which addresses the problematic example of FIG. 5 in the present embodiment will be described. T310 to T326 are the same as T10 to T26 of FIG. 2 except that the AP 900 prepared by the third party is used. T330, T334 are the same as Y30, Y34 of FIG. 5 except that the MFP 10 is used. In the present case, at a timing when T334 is performed, the WPA3 setting information 42 is changed to the setting “WPA3 Only Mode” (T326). Due to this, the MFP 10 does not execute PSK Authentication instead of SAE Authentication. In T336, the MFP 10 causes the display unit 14 to display a connection error indicating that establishment of wireless connection failed.

For example, as indicated in T24A, T26A of FIG. 2, a comparison example in which after the establishment of wireless connection in T50, the WPA3 setting information 42 is changed to the setting “WPA3 Only Mode” is assumed. In this comparison example, at the timing when Authentication is performed, the WPA3 setting information 42 indicates the setting “WPA3 Transition Mode”. Due to this, the problematic example of FIG. 5 may happen. Contrary to this, according to the configuration of the present embodiment, since the WPA3 setting information 42 indicates the setting “WPA3 Only Mode” when Authentication is executed, the problematic example of FIG. 5 can be suppressed from taking place. In a variant, the above comparison example may be adopted, and even in this present comparison example, similar to T70 to T74 of FIG. 2, the third party interception of communication using the AP 800 can be suppressed.

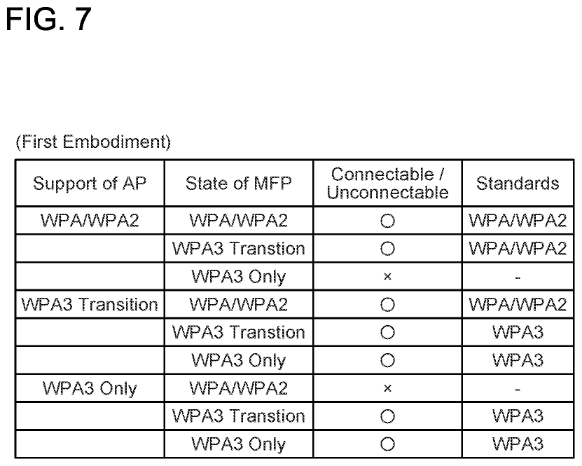

(Table indicating relationship between AP and MFP; FIG. 7) As shown in FIG. 7, according to the formulation of WPA3, there can be, as APs, a WPA3-incompatible AP which supports WPA or WPA2, a WPA3-compatible AP which supports WPA3 Transition Mode, and a WPA3-compatible AP which supports WPA3 Only Mode.

On the other hand, there can be, as MFPs, a WPA3-incompatible MFP, a WPA3-compatible MFP which operates in WPA3 Transition Mode, and a WPA3-compatible MFP which operates in WPA3 Only Mode.

In the present embodiment, the WPA3 setting information 42 of the MFP 10 is changed to the setting “WPA3 Only Mode” (T26 of FIG. 2). Due to this, the MFP 10 can establish wireless connection with either of the WPA3-compatible AP which supports WPA3 Transition Mode and the WPA3-compatible AP which supports WPA3 Only Mode. In both connections, WPA3 is used. On the other hand, the MFP 10 cannot establish wireless connection with the WPA3-incompatible

AP.

(Correspondence Relationship)

The MFP 10, the operation unit 12, the Wi-Fi I/F 16, the print executing unit 20, and the controller 30 are respectively an example of “communication device”, “communication interface”, “operation unit”, “image process executing unit”, and “controller”. The AP 300 and the AP 200 are an example of “first external device” and “second external device”. WPA3 Transition Mode and WPA3 Only Mode are an example of “first state (and fourth state)” and “second state (and third state)”. SAE and PSK are respectively an example of “first communication standard” and “second communication standard”. T22 of FIG. 2 and T222 of FIG. 4 are respectively an example of “instruction for establishing a first connection” and “instruction for establishing a second connection”. The WPA3-compatible information and the WPA3-incompatible information are an example of ““standard information”. The print data of T60 of FIG. 2 is an example of “specific request”. T26 of FIG. 2 is an example of process realized by “change a state of the communication device from a first state to a second state”.

### Second Embodiment

(Configuration of Communication System 2; FIG. 1) A communication system 2 of the present embodiment is the same as that of the first embodiment except the following points. The APs 200, 300 of the present embodiment are both WPA3-incompatible APs, and support WPA2. The AP 200 operates in PMF Capable. The AP 300 operates in PMF Required. Hereafter, being operative in PMF Required may be termed “PR-operative”, and being not operative in PMF Required may be termed “PR-inoperative”. In a variant, the AP 300 may be a WPA3-compatible AP.

The memory 34 of the MFP 10 stores PMF setting information 44 instead of the WPA3 setting information 42. The PMF setting information 44 indicates one of plural items including setting “PMF Capable” and setting “PMF Required”. The setting “PMF Capable” is a setting in which establishment of wireless connection not using PMF and establishment of wireless connection using PMF are both permitted. The setting “PMF Required” is a setting in which the establishment of wireless connection using PMF is permitted and the establishment of wireless connection not using PMF is not permitted.

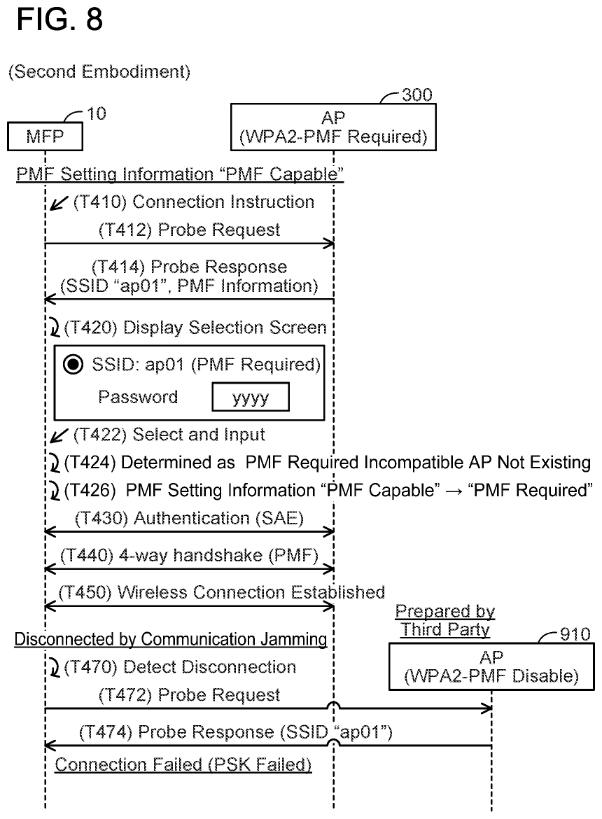

(Specific Case of Present Embodiment; FIG. 8)

With reference to FIG. 8, a specific case of the present embodiment will be described. At the initial stage of the present case, the PMF setting information 44 of the MFP 10 indicates the setting “PMF Capable” by default.

T410 and T412 are the same as T10 and T12 of FIG. 2. T414 is the same as T14 of FIG. 2 except that a Probe response includes PMF information. The PMF information is information which indicates that the AP 300, which is the sending source of the Probe response, operates in PMF Required. If an AP being the sending source of the Probe response does not operate in PMF Required, this Probe response does not include the PMF information.

T420 is the same as T20 of FIG. 2 except that a message indicating whether or not the AP being the sending source of the Probe response is a PR-operative AP is included. T422 is the same as T22 of FIG. 2.

In T424, the MFP 10 determines whether a PR-inoperative AP exists among the one or more surrounding APs. Specifically, the MFP 10 determines whether a Probe response which does not include the PMF information exists among one or more Probe Responses received from the one or more surrounding APs. In the present case, around the MFP 10, one PR-operative AP 300 exists, and no PR-inoperative AP exist. In the present case, in T424, the MFP 10 determines that no PR-inoperative AP exists among the one or more surrounding APs in T424, and proceeds to T426. When it is determined that PR-inoperative AP(s) exist among the one or more surrounding APs, the MFP 10 skips the process of T426, and proceeds to T430 (see FIG. 3 of the first embodiment).

In T426, the MFP 10 changes the PMF setting information 44 from the setting “PMF Capable” to the setting “PMF Required”. T430 to T450 are the same as T30 to T50 of FIG. 2.

In the present case also, similar to FIG. 2, an ill-intentioned third party prepares an AP 910 aiming to intercept communication. The AP 910 is a PR-inoperative AP, and operates in PMF Disable. PMF Disable is a setting in which establishment of wireless connection not using PMF is permitted and establishment of wireless connection using PMF is not permitted. The wireless connection with the AP 910 which does not use PMF has vulnerable security as compared to the wireless connection with the AP 300 using PMF.

T470 to T474 are the same as T70 to T74 of FIG. 2 except that the AP 910 is used. Here, the Probe response of T474 does not include the PMF information.

In the present case, in the above T426, the PMF setting information 44 is changed from the setting “PMF Capable” to the setting “PMF Required”. As mentioned above, in the setting “PMF Required”, the establishment of wireless connection not using PMF is not permitted. In the present case, the AP 910 is an AP of PMF Disable. Due to this, the AP 910 notifies the MFP 10 of not using of PMF in 4-way handshake communication. Since, however, the MFP 10 does not permit the establishment of wireless connection not using PMF, the 4-way handshake communication fails. As a result of this, the establishment of wireless connection between the AP 910 and the MFP 10 fails. In the present case also, wireless connection is not established between the AP 910 and the MFP 10, and the third party interception of communication using the AP 910 can be suppressed.

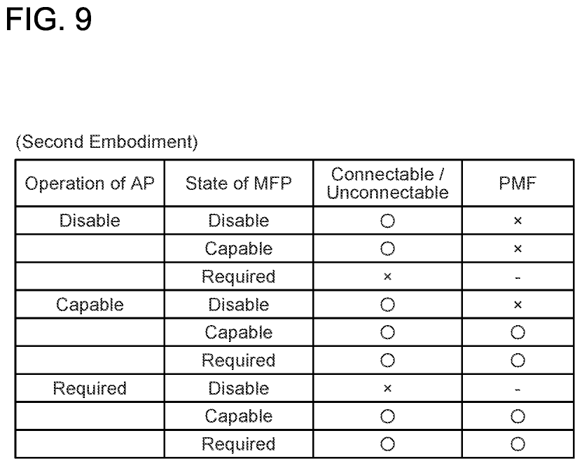

(Table indicating relationship between AP and MFP; FIG. 9)

As shown in FIG. 9, according to the formulation of PMF, there may be, as APs, a PR-inoperative AP which operates in PMF Disable, a PR-inoperative AP which operates in PMF Capable, and a PR-operative AP which operates in PMF Required.

On the other hand, as MFPs, there may be an MFP which operates in PMF Disable, a

WPA3-compatible MFP which operates in PMF Capable, and a WPA3-compatible MFP which operates in PMF Required.

In the present embodiment, the PMF setting information 44 of the MFP 10 is changed to the setting “PMF Required” (T426 of FIG. 8). Due to this, the MFP 10 is able to establish wireless connection with either of the PR-inoperative AP which operates in PMF Capable and the PR-operative AP which operates in PMF Required. In both connections, PMF is used. On the other hand, the MFP 10 is not able to establish wireless connection (i.e., wireless connection in which PMF is not used) with the PR-inoperative AP which operates in PMF Disable.

(Correspondence Relationship) PMF Capable and PMF Required are respectively an example of “first state (and fourth state)” and “second state (and third state)”.

### Third Embodiment

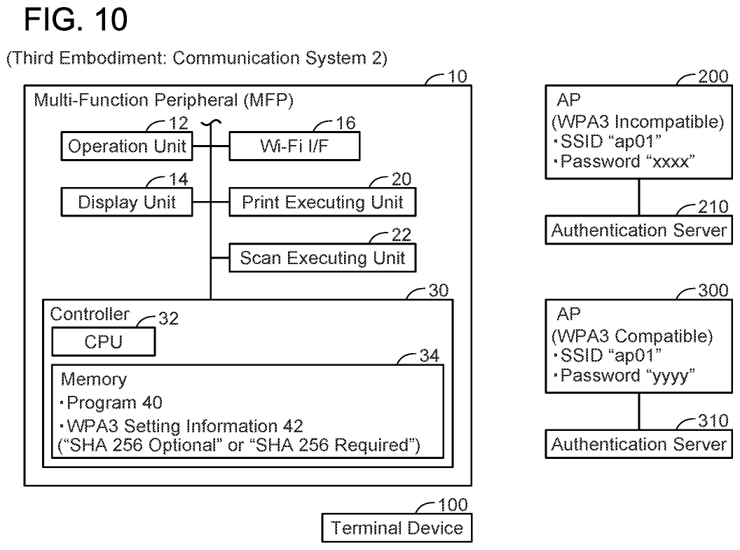

(Communication System 2; FIG. 10) In the present embodiment, the MFP 10 uses Enterprise. As mentioned above, Enterprise is a communication standard used in companies, for example. Enterprise is provided not only in WPA3 but also in WPA2.

A communication system 2 of the present embodiment is the same as the communication system 2 of the first embodiment except that it comprises authentication servers 210 and 310 and the content of the WPA3 setting information 42 is different.

The authentication servers 210, 310 are each an authentication server used in Enterprise.

The authentication server 210 is used in a process for establishing wireless connection with the AP 200, and is connected to the AP 200 via a wired LAN. The authentication server 310 is used in a process for establishing wireless connection with the AP 300, and is connected to the AP 300 via a LAN (wired or wireless).

Further, the WPA3 setting information 42 of the present embodiment indicates one of plural items including setting “SHA256 Optional” and setting “SHA256 Required”. The setting “SHA256 Optional” is a setting in which, in communication with an authentication server in Enterprise, use of a hash function (for example SHA1) available in both of WPA2 and WPA and use of a hash function “SHA256” available in WPA3 but not available in WPA2 and WPA are both permitted. That is, when the WPA3 setting information 42 indicates the setting “SHA256 Optional”, establishment of wireless connection conforming to WPA2 or WPA and the establishment of wireless connection conforming to WPA3 are both permitted. Here, the hash function available in WPA3 may not be limited to SHA256 but may be, for example, SHA384, SHA3.

On the other hand, the setting “SHA256 Required” is a setting in which, in communication with an authentication server in Enterprise, use of the hash function “SHA256” is permitted and use of a hash function available in both WPA2 and WPA is not permitted. That is, when the WPA3 setting information 42 indicates the setting “SHA256 Required”, the establishment of wireless connection conforming to WPA3 is permitted, and the establishment of wireless connection conforming to WPA2 or WPA is not permitted. Here, in the setting “SHA256 Required”, use of SHA384, SHA3 may be permitted.

SHA256 is a hash function which outputs a return value of 256 bit length. The length of the return value of SHA256 is longer than a length of return value of SHA1. An encryption level of SHA256 is greater than an encryption level of SHA1.

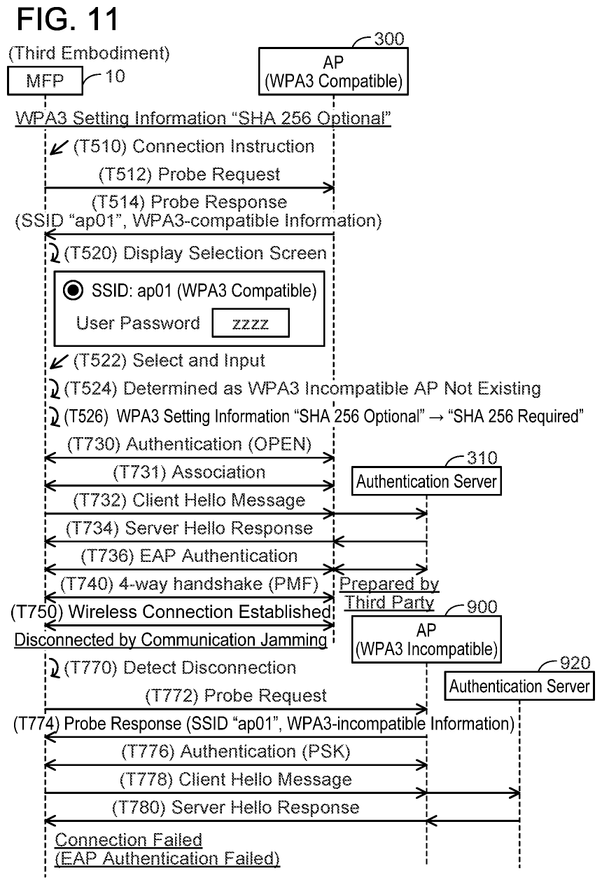

(Specific Case of Present Embodiment; FIG. 11)

With reference to FIG. 11, a specific case of the present embodiment will be described. At the initial stage of the present case, the WPA3 setting information 42 of the MFP 10 indicates the setting “SHA256 Optional” by default.

T510 to T514 are the same as T10 to T14 of FIG. 2. The WPA3-compatible information of T514 includes information indicating the hash function “SHA256” to be used in communication with an authentication server. In T526, the MFP 10 changes the WPA3 setting information 42 from the setting “SHA256 Optional” to the setting “SHA256 Required”.

T520 is the same as T20 of FIG. 2 except that the selection screen includes an input column of a user password used for authentication in the authentication server instead of the AP password input column T522 is the same as T22 of FIG. 2 except that a user password “zzzz” stored in the authentication server 310 in association with a user name indicating the user of the MFP 10 is inputted in the user password input column. T524 is the same as T24 of FIG. 2.

T730 is the same as T30 of FIG. 2 except that authentication of OPEN is performed instead of the SAE Authentication. In T731, communication of Association is performed between the MFP 10 and the AP 300.

In T732, the MFP 10 sends a Client Hello message to the authentication server 310 via the AP 300. The communication between the MFP 10 and the AP 300 is encrypted according to Transport Layer Security (TLS). The Client Hello message is a message which notifies the authentication server 210 that the MFP 10 is to start operating as a client of TLS.

In T734, the MFP 10 receives a Server Hello message as a response to the Client Hello message from the authentication server 210 via the AP 300. The Server Hello message is a message which notifies the MFP 10 that the authentication server 310 is to start operating as a server of TLS.

In T736, the MFP 10 performs communication of Extensible Authentication Protocol (EAP) with the authentication server 310 according to TLS via the AP 300. The EAP authentication includes a user authentication and exchange of keys. The user authentication is communication for the authentication server 210 to authenticate the user of the MFP 10 by using the user password received from the MFP 10. The exchange of keys is communication for the authentication server 210 to provide encryption keys to be used in a communication of T740 (to be described later) to both the MFP 10 and the AP 300 when the user authentication succeeds.

T740 is the same as T70 of FIG. 3 except that the encryption keys that were provided in the EAP authentication are used. T750 is the same as T50 of FIG. 2.

In the present case, an ill-intentioned third party prepares the AP 900 and an authentication server 920 aiming to intercept communication. The authentication server 920 is a server configured to perform EAP authentication conforming to WPA2. For example, the authentication server 920 performs the EAP authentication using the hash function “SHA1”.

T770 to T774 are the same as T70 to T74 of FIG. 2. T776 is the same as T730 except that PSK authentication is performed. T778, T780 are the same as T732, T734 except that the AP 900 and the authentication server 920 are used.

In the present case, in the above T526, the WPA3 setting information 42 was changed from the setting “SHA256 Optional” to the setting “SHA256 Required”. As mentioned above, in the setting “SHA256 Required”, communication with an authentication server using the hash function “SHA1” is not permitted. In the present case, the authentication server 920 uses the hash function “SHA1”. Due to this, the authentication server 920 notifies the MFP 10 that the hash function “SHA1” is to be used. Since the use of the hash function “SHA1” is not permitted by the MFP 10, however, the EAP authentication fails. As a result of this, establishment of wireless connection between the AP 900 and the MFP 10 fails. In the present case also, no wireless connection is established between the AP 900 and the MFP 10, and thus the third party interception of communication using the AP 900 can be suppressed.

(Correspondence Relationship)

SHA256 Optional and SHA256 Required are respectively an example of “first state (and fourth state)” and “second state (and third state)”.

### Fourth Embodiment

In the present embodiment, the MFP 10 performs communication with a management server configured to manage a state of the MFP 10. The communication between the MFP 10 and the management server is performed according to Transmission Control Protocol (TCP). Further, the communication between the MFP 10 and the management server is encrypted according to TLS. For example, the MFP 10 sends periodically information indicating the state of the MFP 10 (for example, ink remaining amount) to the management server.

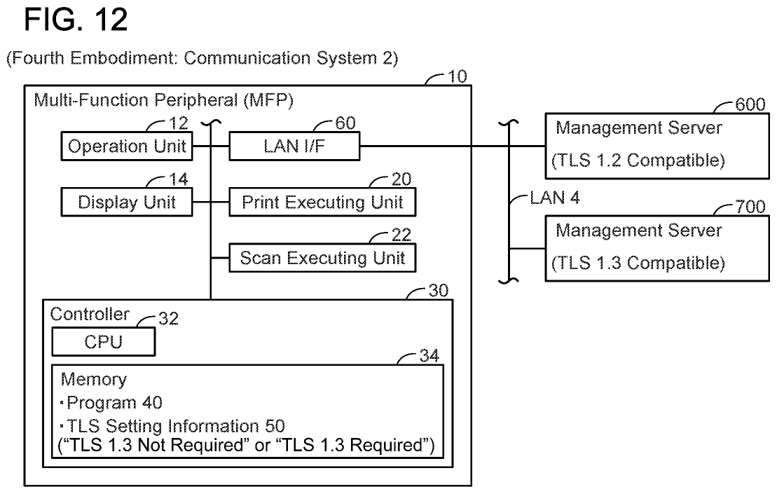

(Configuration of Communication System 2; FIG. 12)

A communication system 2 of the present embodiment is the same as the communication system 2 of the first embodiment except that it comprises management servers 600, 700 instead of the APs 200, 300 and that the configuration of its MFP 10 is different.

The management server 600 supports TLS of version 1.2. The management server 700 supports TLS of new version 1.3 which was formulated later than Version 1.2. The management servers 600 and 700 are each connected to the LAN 4. The LAN 4 is a wired LAN. It should be noted that “1.3” is merely a number for indicating the latest version, and is merely an example.

(Configuration of MFP 10; FIG. 12)

An MFP 10 of the present embodiment is the same as that of the first embodiment except that it comprises a LAN I/F 60 instead of the Wi-Fi I/F 16 and that it stores TLS setting information 50 instead of the WPA3 setting information 42. The LAN I/F 60 is an I/F configured to perform communication via the LAN 4 and is connected to the LAN 4. The MFP 10 of the present embodiment supports TLS of version 1.3.

The TLS setting information 50 indicates one of plural items including setting “TLS 1.3 Not Required” and setting “TLS1.3 Required”. The setting “TLS1.3 Not Required” is a setting in which TLS of version 1.3 and TLS of version 1.2 or earlier are both permitted. The setting “TLS1.3 Required” is a setting in which the use of TLS version 1.3 is permitted and the use of TLS of version 1.2 or earlier is not permitted.

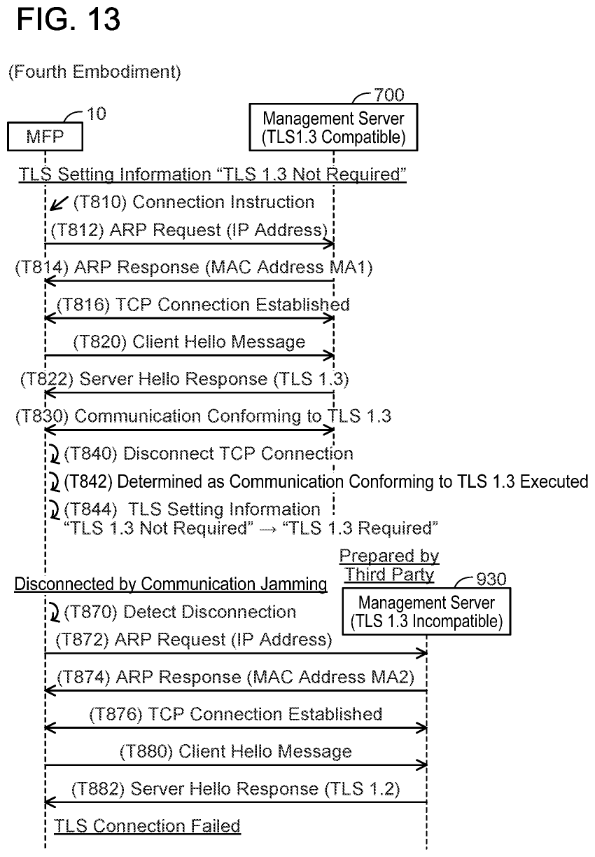

(Specific Case of Present Embodiment; FIG. 13) With reference to FIG. 13, a specific case of the present embodiment will be described.

At the initial stage of the present case, the TLS setting information 50 of the MFP 10 indicates “TLS1.3 Not Required” by default. All of the communications performed by the MFP 10 of the present embodiment will be performed via the LAN I/F 60. Hereafter, a recitation “via the LAN I/F 60” may be omitted when a process related to communication is explained.

In the present case, a situation in which the management server 700 is newly installed in addition to the management server 600, is assumed. In the present case, the user inputs an IP address of the management server 700 instead of an IP address of the management server 600 to the MFP 10.

In T810, the user operates the operation unit 12 of the MFP 10, and inputs an instruction for TCP connection with the management server 700. For example, communication between the MFP 10 and the management servers is periodically performed while power of the MFP 10 is ON. Connection conforming to TCP (hereafter TCP connection) with the management server 700 is established by a trigger of power of the MFP 10 being turned on after the IP address of the management server 700 has been inputted. An instruction of turning on the power of the MFP 10 in T810 may be regarded as an instruction for the TCP connection with the management server 700.

In T812, the MFP 10 sends an Address Resolution Protocol (ARP) request addressed to the IP address of the management server 700. The ARP request is a request for requesting for a MAC address of a management server.

In T814, the MFP 10 receives an ARP response including a MAC address MA1 of the management server 700 as a response to the ARP request of T812 from the management server 700. In T816, a TCP connection is established between the MFP 10 and the management server 700.

In T820, the MFP 10 sends a Client Hello message using the established TCP connection to the management server 700. In T822, the MFP 10 receives a Server Hello Response using the established TCP connection from the management server 700. This Server Hello Response includes information indicating that the management server 700 supports TLS of version 1.3.

In T830, between the MFP 10 and the management server 700, communication conforming to TLS of version 1.3 is performed using the established TCP connection. This communication includes, for example, sending of information indicating the state of the MFP 10 to the management server.

In subsequent T840, the MFP 10 cuts off the TCP connection of T816 by a trigger of a user's predetermined operation. The predetermined operation is an operation for turning off the power of the MFP 10, for example.

In T842, the MFP 10 determines whether or not there is a history that communication conforming to TLS of version 1.3 was performed. In the present case, in T830 the communication conforming to TLS of version 1.3 was performed. In the present case, the MFP 10 determines that there is the history that communication conforming to TLS of version 1.3 was performed, and proceeds to process of T844. Here, if the MFP 10 determines there is no history that communication conforming to TLS of version 1.3 was performed, the process of T844 is to be skipped.

In T844, the MFP 10 changes the TLS setting information 50 from the setting “TLS1.3 Not Required” to the setting “TLS1.3 Required”.

In the present case also, an ill-intentioned third party prepares a management server 930 aiming to intercept communication. The management server 930 does not support TLS of version 1.3. The management server 930 supports an older version (for example 1.2) that was formulated before version 1.3, for example. In TLS, a new security protocol is provided along with a version update. Communication conforming to TLS of an older version that was formulated before version 1.3 has vulnerable security compared to the communication conforming to TLS of version 1.3.

The third party firstly intercepts communication between the management server 700 and the MFP 10 and cuts off the TCP connection with the management server 700. In T872, the MFP 10 detects this disconnection of the TCP connection. To attempt re-establishing a TPC connection, the MFP 10 sends an ARP request directed to the IP address of the management server 700 in T872. Here, the third party illegally sets the IP address of the management server 930 to be the same IP address as the IP address of the management server 700. As a result of this, in T874, the MFP 10 receives an ARP response including a MAC address MA2 of the management server 930 from the management server 930.

In T876, a TCP connection is established between the MFP 10 and the management server 930. T880 is the same as T820 except that the management server 930 is used. T882 is the same as T822 except that the Server Hello message includes information indicating that the management server 930 supports TLS of version 1.2 or earlier (for example 1.2).

In the present case, in the above T844, the TLS setting information 50 is changed to the setting “TLS1.3 Required”. As mentioned above, the setting “TLS1.3 Required” is a setting in which the use of TLS of version 1.2 or earlier is not permitted. In the present case, the management server 930 supports TLS of version 1.2 or earlier. Due to this, the MFP 10 does not permit execution of communication conforming to TLS of version 1.3, and the information indicating, for example, the state of the MFP 10 is not sent to the management server 930. The third party interception of communication using the management server 930 can be suppressed.

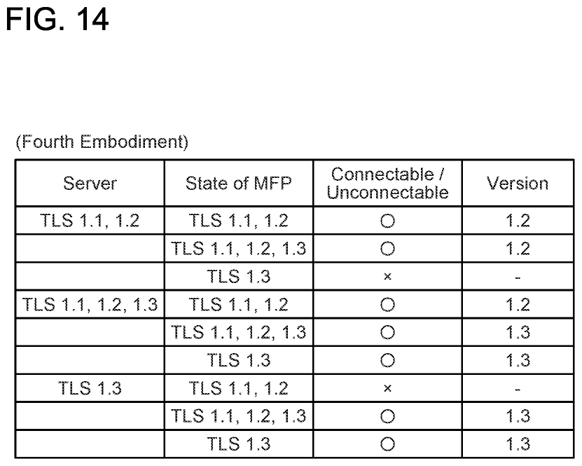

(Table indicating Management Server and MFP; FIG. 14) As shown in FIG. 14, there may be a server which supports TLS of version 1.2 or earlier, a server which supports TLS of version 1.3 or earlier, and a server which supports TLS of version 1.3 only.

On the other hand, as MFPs, there may be an MFP which supports TLS of version 1.2 or earlier, an MFP which supports TLS of version 1.3 or earlier, and a WPA3-compatible MFP which supports TLS of version 1.3 only.

In the present embodiment, the TLS setting information 50 of the MFP 10 is changed to the setting “TLS1.3 required” (T844 of FIG. 13). Due to this, the MFP 10 can perform communication using TCP connection with either of the server which supports TLS of version 1.3 or earlier or the server which supports TLS of version 1.3 only. On the other hand, the MFP 10 cannot perform communication using TCP connection with the server which supports TLS of version 1.2 or earlier.

(Correspondence Relationship)

The LAN I/F 60 in FIG. 12 is an example of “communication interface”. The management server 700 and the management server 600 are respectively an example of “first external device” and “second external device”. TLS1.3 Not Required and TLS1.3 Required are respectively an example of “first state (and fourth state)” and “second state (and third state)”. Version 1.3 and version 1.2 are respectively an example of “first version” and “second version”. TLS of version 1.3 and TLS of version 1.2 are respectively an example of “first communication standard” and “second communication standard”. The connection instruction in T810 of FIG. 13 is an example of “instruction for establishing a first connection”. T844 is an example of a process realized by “change a state of the communication device from a first state to a second state”.

(Variant 1) The process of Case C3 of FIG. 4 may not be performed.

In the present variant, “change the state of the communication device from the second state to the first state” may be omitted.

(Variant 2) The process of Case C2 of FIG. 3 may not be performed. Generally speaking, “the state of the communication device” may not be “maintained in the first state”.

(Variant 3) The processes of T60, T62 of FIG. 2 may not be performed. In the present variant, “an image process executing unit”, “establish the first connection”, “receive a specific request”, and “cause the image process executing unit to execute the specific image process” may be omitted.

(Variant 4) The “communication device” may not be limited to the MFP 10, but may be for example, a terminal device such as a printer, a scanner, and a PC.

(Variant 5) The “server” may not be limited to the management server 600, etc. which manages the state of the MFP 10, but may be for example, an email server configured to send emails in accordance with an instruction from the MFP 10.

(Variant 6) In the embodiments above, the processes of FIGS. 2 to 14 are implemented by software (e.g., the program 40 etc.), however, at least one of the processes may be implemented by hardware such as a logic circuit, etc.

A reference example described below is novel and useful also. In the fourth embodiment, the MFP 10 sends an ARP request to the management server 700 by a trigger of input of an instruction for TCP connection after the input of the IP address of the management server 700 (T810, T812 of FIG. 13). Instead of this, the process of T810 may not be performed, and the MFP 10 may send automatically the ARP request at a predetermined time after the input of the IP address of the management server 700 to the management server 700. Generally speaking, “controller” may be configured to change the state of the communication device from the first state to the second state different from the first state at a predetermined time in a while the state of the communication device is the first state, the predetermined timing being when the first connection with the first external device via the communication interface is to be established.

What is claimed is:

1. A communication device comprising:
a communication interface;
an operation unit; and
a controller,
wherein
the controller is configured to:
change a state of the communication device from a first state to a second state being different from the first state in a case where the operation unit receives an instruction for establishing a first connection with a first external device via the communication interface while the state of the communication device is the first state,
wherein
the first state is a state in which both use of the first connection and use of a second connection with a second external device via the communication interface are permitted,
the second state is a state in which the use of the first connection is permitted and the use of the second connection is not permitted,
the first connection is a connection conforming to a first communication standard, and
the second connection is a connection conforming to a second communication standard being different from the first communication standard.

2. The communication device as in claim 1, wherein
the state of the communication device is changed from the first state to the second state before the first connection is established with the first external device in response to the instruction for establishing the first connection.

3. The communication device as in claim 1, wherein
the state of the communication device is changed from the first state to the second state after the first connection has been established with the first external device in response to the instruction for establishing the first connection.

4. The communication device as in claim 1, wherein
the controller is further configured to:
change the state of the communication device from the second state to the first state in a case where the operation unit receives an instruction for establishing the second connection while the state of the communication device is the second state.

5. The communication device as in claim 1, wherein
both the first external device and the second external device are access points, and
both the first connection and the second connection are wireless connections.

6. The communication device as in claim 5, wherein
a Service Set Identifier (SSID) of a wireless network formed by the first external device is identical to a SSID of a wireless network formed by the second external device,
the controller is further configured to:
from each of one or more external devices existing around the communication device, receive standard information indicating a communication standard supported by a respective external device while the state of the communication device is the first state,
wherein in a case where the one or more external devices include both the first external device and the second external device, and the received one or more pieces of standard information include first standard information indicating that the first external device supports the first communication standard and second standard information indicating that the second external device supports the second communication standard, the state of the communication device is maintained in the first state even when the operation unit receives the instruction for establishing the first connection.

7. The communication device as in claim 6, wherein
the first communication standard includes WPA3 in a Wi-Fi standard, and
the second communication standard includes a standard being WPA2 or an earlier version in the Wi-Fi standard.

8. The communication device as in claim 7, wherein
the first state includes WPA3 Transition Mode conforming to WPA3, and
the second state includes WPA3 Only Mode conforming to WPA3.

9. The communication device as in claim 7, wherein
the first state includes a state in which both first authentication and second authentication are permitted,
the second state includes a state in which the first authentication is not permitted and the second authentication is permitted,
wherein the first authentication is of Pre-Shared Key (PSK) scheme available in a standard being WPA2 or an earlier version, and
the second authentication is of Simultaneous Authentication of Equals (SAE) scheme available in WPA3 and not available in the standard being WPA2 or an earlier version.

10. The communication device as in claim 7, wherein
the first state includes a state in which both use of a first hash function and use of a second hash function are permitted,
the second state includes a state in which the use of the first hash function is not permitted and the use of the second hash function is permitted,
the first hash function is available in both WPA3 and a standard being WPA2 or an earlier version, and
the second hash function is available in WPA3 and not available in the standard being WPA2 or an earlier version.

11. The communication device as in claim 5, wherein
both the first communication standard and the second communication standard include Wi-Fi standard,
the first communication standard includes Protected Management Frames (PMF),
the second communication standard does not include PMF,
the first state includes a state indicated by PMF Capable, and
the second state includes a state indicated by PMF Required.

12. The communication device as in claim 1, further comprising an image process executing unit configured to execute a specific image process, wherein
the controller is further configured to:
in a case where the operation unit receives the instruction for establishing the first connection, establish the first connection with the first external device;
after the first connection has been established, receive a specific request for requesting to execute the specific image process from the first external device by using the first connection via the communication interface; and
cause the image process executing unit to execute the specific image process according to the specific request.

13. The communication device as in claim 1, wherein
both the first external device and the second external device are servers, the first communication standard includes a first version of Transport Layer Security (TLS) which is used in a communication with the server,
the second communication standard includes a second version of TLS which was formulated before the first version,
the first state includes a state in which both use of the first version and use of the second version are permitted, and
the second state includes a state in which the use of the first version is not permitted and the use of the second version is permitted.

14. The communication device as in claim 1, wherein
a default state of the communication device after power of the communication device has been turned ON is the first state.

15. A communication device comprising:
a communication interface;
an operation unit; and
a controller, wherein
the controller is configured to:
cause the communication device to operate in a third state in a case where the operation unit receives an instruction for establishing a first connection with a first external device via the communication interface; and
cause the communication device to operate in a fourth state in a case where the operation unit receives an instruction for establishing a second connection with a second external device via the communication interface,
wherein the third state is a state in which use of the first connection is permitted and use of the second connection is not permitted,
the fourth state is a state in which both the use of the first connection and the use of the second connection are permitted,
the first connection is a connection conforming to a first communication standard, and
the second connection is a connection conforming to a second communication standard being different form the first communication standard.

16. A non-transitory computer-readable medium storing computer-readable instructions for a communication device, wherein the communication device comprises:
a communication interface;
an operation unit; and
a processor, wherein
the computer-readable instructions, when executed by the processor, cause the communication device to:
change a state of the communication device from a first state to a second state being different from the first state in a case where the operation unit receives an instruction for establishing a first connection with a first external device via the communication interface while the state of the communication device is the first state,
wherein
the first state is a state in which both use of the first connection and use of a second connection with a second external device via the communication interface are permitted,
the second state is a state in which the use of the first connection is permitted and the use of the second connection is not permitted,
the first connection is a connection conforming to a first communication standard, and the second connection is a connection conforming to a second communication standard being different from the first communication standard.

17. A non-transitory computer-readable medium storing computer-readable instructions for a communication device, wherein the communication device comprises:
a communication interface;
an operation unit; and
a processor, wherein
the computer-readable instructions, when executed by the processor, cause the communication device to:
cause the communication device to operate in a third state in a case where the operation unit receives an instruction for establishing a first connection with a first external device via the communication interface; and
cause the communication device to operate in a fourth state in a case where the operation unit receives an instruction for establishing a second connection with a second external device via the communication interface,
wherein the third state is a state in which use of the first connection is permitted and use of the second connection is not permitted,
the fourth state is a state in which both the use of the first connection and the use of the second connection are permitted,
the first connection is a connection conforming to a first communication standard, and
the second connection is a connection conforming to a second communication standard being different form the first communication standard.
